(19) United States
(12) Patent Application Publication
(10) Pub. No.: US 2025/0022473 A1
(43) Pub. Date: Jan. 16, 2025

(54) DETECTION OF AN AUDIO DEEP FAKE AND NON-HUMANS SPEAKER FOR AUDIO CALLS

(71) Applicant: Red Bend Ltd., Hod Hasharon (IL)

(72) Inventor: Tali Eilam Tzoreff, Herzliya (IL)

(21) Appl. No.: 18/715,651

(22) PCT Filed: Dec. 2, 2021
(86) PCT No.: PCT/IL2021/051443

§ 371 Date: May 31, 2024

(51) Int. Cl. G10L 17/26; G10L 17/02; G10L 17/04; G10L 17/18

(52) U.S. Cl. CPC G10L 17/26; G10L 17/02; G10L 17/04; G10L 17/18

(57) ABSTRACT

A computer implemented system for authenticating an audio conversation occurring between a human target and an unknown speaker. The system adjusts messages sent to the speaker to include characteristics that evoke different responses in bots controlling vocoders to generate deepfakes than are evoked in humans. By analyzing these responses, harms from deepfake threats can be avoided by turning the tools used by deepfake generating bots against those very bots.

### BACKGROUND

Audio deepfakes are artificially generated audio signals which replace the likeness of one or more people with digital audio signals. Often deepfakes utilize artificial intelligence to deceptively impersonate a specific human speaker. Unfortunately, audio deepfakes can be used to further all sorts of nefarious goals such as fraud, theft, slander, counterfeiting, and other criminal activities.

### BRIEF DESCRIPTION OF THE SEVERAL VIEWS OF THE DRAWINGS

Some embodiments relate to verifying the human source of an audio signal and, more specifically, but not exclusively, to detecting vocoder generated audio deepfakes especially via telephones and/or when operating automobiles. Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a flowchart illustrating the process of detecting a deepfake, according to some embodiments of the present description;

FIG. 2 is an illustration of the detection of a deepfake received by a phone, according to some embodiments of the present description;

FIG. 3 is an illustration of the detection of a deepfake in an automobile, according to some embodiments of the present description;

FIG. 4 is flowchart illustrating the process of machine learning used to analyze a reply to detect a deepfake, according to some embodiments of the present description; and

FIG. 5 is an illustration of a computer system for detection of a deepfake, according to some embodiments of the present description.

For the purposes of this disclosure, like reference numerals in the figures shall refer to like features unless otherwise indicated. The drawings are only exemplifications and are not intended to limit the disclosure to the particular embodiments illustrated.

### DETAILED DESCRIPTION

Some embodiments relate to verifying the human source of an audio signal and, more specifically, but not exclusively, to detecting vocoder generated audio deepfakes especially via telephones and/or when operating automobiles.

Unless otherwise defined, all technical and/or scientific terms used herein have the same meaning as commonly understood by one of ordinary skill in the art to which the embodiments are directed. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Audio deepfake is machine generated audio signal which impersonates the voice of a specific person or category of person. Although audio deepfake does have some benefits, these benefits are increasingly outweighed by the growing risk of its use as a tool for fraud and crime. This risk however is increasing as the quality of the deepfakes are continually improving and are becoming almost indistinguishable from a real person's voice (the correct one of these being the “speaker”) when heard by another human listener (the “target”). Even worse, the risk and effects of audio deepfake can be compounded by combining it with visual or video deepfake.

Understanding how audio deepfake is generated provides strategies for detecting deepfake. Typically, the first step in creating a deepfake is to create a language informational model which can simulate the speech of a subject. The model is taught to express a specific language. Audio samples of human language to be impersonated (the “subject”) are fed to the model which facilitates reproduction of audio signals from the subject. Audio samples of the subject speaking numerous words are gathered to match nuanced audio patterns to specific words of the language. The more samples the better, and often hours or even days' worth of audio samples of a subject are fed into the model. Transcripts of the audio samples are organized to match word with the subject's unique sounds. The model is fed with the recordings and the transcripts. Often text and audio segments of the audio samples given to the model are of various lengths, ranging from 1-2 seconds to hours to define specific words and expressions of the subject. The model then performs various calculations to establish a correlation between the expected sound of the subject expressing various words. This results in the generic base model in the desired language for the subject.

The base model can then be fine-tuned for greater precision. The fine tuning may take longer to train the base model to more accurately impersonate the subject's voice by utilizing even more voice recordings of the desired speaker are necessary to achieve a good result. However, often the results obtained from this fine-tuning still sound relatively metallic and robot-like. The reason for this is that in truth, each human speaker has a huge variety of expressions and voice patterns and that cannot be simulated by a mere collection of recorded words indexed to text. Thus, in order to turn the metallic voice into a better sounding imitation or an unrecognizable imitation of the voice, one last step is employed. The results obtained are fed into an artificial neural network which uses recursive machine learning to fill in the gaps between the collected audio samples of the subject and predictions of what sounds the subject would make of other words and expressions outside of the sample set. A vocoder device is then used to generate sounds that are close to indistinguishable by a human listener from the subject's authentic voice, a deepfake.

A number of techniques have been developed to detect deepfake audio signals. One such technique involves analyzing an audio sample to detect the presence of audio elements that can be generated by a vocoder but which would not be generated by a human voice. Depending on the quality of a given audio sample of purported human speech, every second can contain between 8,000-50,000 or more, or less discrete data samples that can be analyzed. The technique scrutinizes these samples for recognizable constraints on human speech. For example, two vocal sounds have a minimum possible separation from one another because it isn't physically possible to say them any faster due to the speed with which the muscles in a human mouth and vocal cords can reconfigure. The existence of shorter separation between consecutive vocal sounds is an indication that the speech is synthetic and thus a deepfake.

A second technique involves scrutinizing particular components of speech such as fricatives and terminals in an audio sample. Fricatives are a class of sounds formed when air passes through a narrow constriction the throat when pronouncing letters like f, s, v, and z. Fricatives are especially hard for machine learning systems to master because it is very difficult for software to differentiate fricatives from background noise. A terminal is the end of a given word. Audio analyzing software have difficulty distinguishing between word terminals and background noise. This results in synthetic voice samples that trail off in a manner dissimilar to how natural human speech ends words. Existing fake audio detection algorithm uses statistics on how often these occur in a human voice to detect fakes. Other techniques look for other artifacts of vocoder activity or limits of software capabilities embedded within audio samples to distinguish deepfake audio from natural audio. One thing all of these techniques have in common is they are passive and reactive. They analyze received audio samples but do not play any role in the actual creation of the audio samples.

At least one example of the present description is directed to manipulating the source of an audio sample into generating an audio output which contains one or more audio property which includes components that would not be generated by a bona fide human speaker but would be generated by a deepfake generating vocoder. For example, an audio sample generated by a potential target of a deepfake is subjected to a change to test whether a party speaking with the target is human or not. The change can be something akin to a change in the target's voice and/or speech content. This change functions as a “test” to determine when the response is one that a human would produce or one that a deepfake would produce. This is done by manipulations to the target's audio that strike a human caller as noticeable and due a response, and but which go unnoticed by a non-human speech generator.

For example, a target many be engaged in a conversation with a speaker that is not yet determined to be a human or a deepfake generating bot. The speech of the target is captured by an information system and converted from analog to a digital audio signal. Speech to text conversion may be applied to the audio signal as well. The system then “intervenes” in the conversation by applying some changes to one or more audio property of the digital representation of the target's voice. The change is such that a bot which just analyzes the text of the audio signal would not note to be significant, but a human interlocutor would find the audio property strikingly odd. The system may apply accent or intonation changes to a few phrases of the target's audio signal. It may use a child, elderly person, other gender or a celebrity voice to say an additional filler phrase. It may repeat a phrase said by the caller during the call using the caller's own voice. It may insert a gibberish phrase such as ‘did you say that: bla bla bla’ using the speaker's recording of the phrase. It may add some audio coming from an imaginary third party to the conversation. Other representative examples of changes in audio property include inconsistencies, relative to the relative context, in one or more of language, the presence of random phonemes, language fluency, audio gain, accent, jargon, intimacy, familiarity, vocabulary, grammatical tense, genre, subject matter, coherence, repetition, courtesy, grammatical conjugation, formality, harmony, musicality, bass, treble, laughter, crying, screaming, profanity, and emotion, volume, pace, and word sequence.

In an example of the present description, either when to insert an intervention and the which specific intervention to insert, or both are generated either by rule-based engine and/or by a machine language technique.

In one or more examples of the present description, the audible changes to the target's response are aimed at speech which would make a human interlocuter uneasy. A bot however, especially one which is only analyzing the text of the target's speech would find the conversation completely normal and reply in due course. In contrast, a human interlocuter would interpret the audible changes as something strange and would be expected to react to it. The reaction could be one of incredulity (for example “are you kidding me”) or some other audible reaction of unease like tone of embarrassment, hesitation etc.

In one or more examples of the present description, the system analyzes the speaker's response to detect any such reaction. This analysis may be performed with a machine learning technique which is trained to detect the appearance or absence of audible discomfort in tone or in the text. In an example of the present description, a threshold is established to define a quantifiable measurement of discomfort in the speaker. In this manner, a level of credibility can be set in which a stricter or more lenient setting can be set to designate the speaker as human or deepfake.

In one or more examples of the present description, the system is operated in a telephone system. As such, the target is in a telephone conversation with the speaker and the system will indicate if the speaker is a human or a deepfake. In one or more examples of the present description, upon designation of the speaker, the system may disconnect the conversation, may provide an indication to the target that the speaker is or may be a deepfake, or may communicate relevant information to the target or engage in some other response. In an example of the present description the response includes a suggestion regarding who to alert based on analysis of the content of the conversation. For example, if the target was asked to withdraw money from his bank account the suggested alert could be to the bank branch/es where his accounts are managed.

In one or more examples of the present description, the system may be modulated by the subject matter of the conversation. If the conversation is of an innocuous subject (such as trivia or the weather) the system may not activate the intervention or may only reply to an exceptionally high threshold analysis of the before engaging in some sort of response. In contrast, if the subject matter of the conversation shifts to a sensitive subject (such as finance, medicine, or confidential matters), the system may adjust the threshold to a more sensitive setting for determining if some sort of response is due.

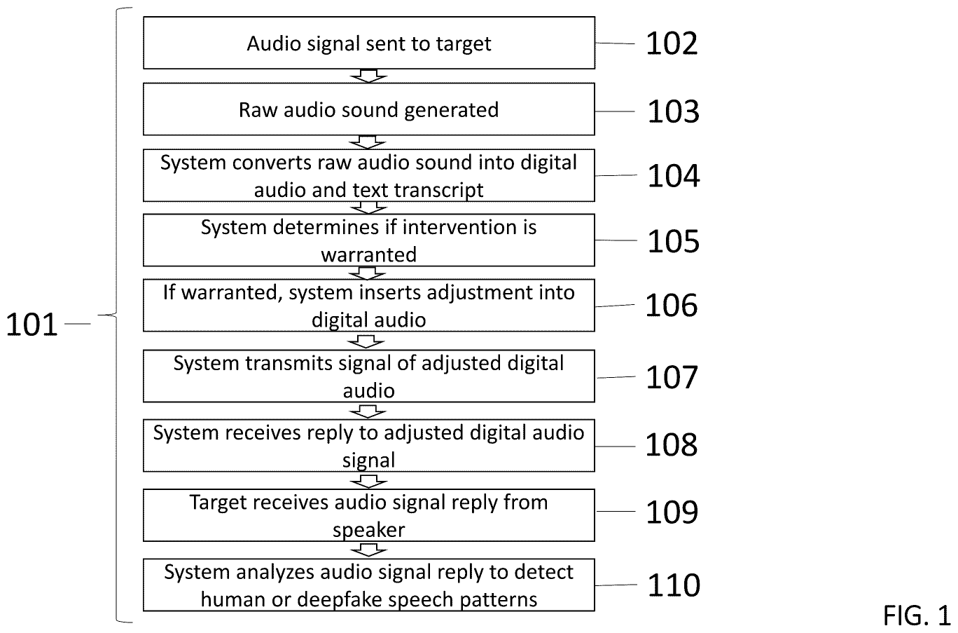

Referring now to FIG. 1 there is shown an example of the system (101) for detecting a deepfake audio signal, according to an example of the present description. The system includes one or more processing circuitries which controls the operation and interaction between an audio input, a receiver, a transmitter, and audio output. The receiver is constructed and arranged to receive a broadcast signal (102) sent from the speaker. The broadcast may be any electromagnetic or photonic signal and comprises an encoded audio signal. The signal is decoded and converted into sound by a processor and the sound is emitted via the audio output in a form within the audio range of human hearing. The audio input (103) can receive sounds from a human target which are then encoded into the requisite electromagnetic or photonic signal and transmitted by the transmitter in reply to the broadcast. A representative audio input (103) is a microphone or audio sensor. The processing circuitries are constructed and arranged to analyze and/or alter the audio signals (104). The analysis may involve formatting the signal into a text format or other format susceptible to parsing and interpretation. A processor associates regions of the formatted signal to characterize an important attribute of the signal such as subject matter, sensitivity, intended target, or other criteria. A processor applies logic to determine if based on one or more criteria, if the signal warrants an intervention (105). When warranted, a processor inserts one or more adjustments into the formatted signal (106) utilizing the same format. The formatted signal, now bearing the adjustment is encoded into electromagnetic or photonic format and is transmitted by the transmitter back to the speaker (107).

When a reply signal from the speaker is subsequently received by the receiver (108) the effect of the adjusted format on the nature of the reply signal is assessed by a processor (109). This assessment, utilizing one or more algorithms and/or heuristics affords a determination if the reply signal from the speaker is in fact from a bona fide human communication or is a vocoder generated deepfake (110).

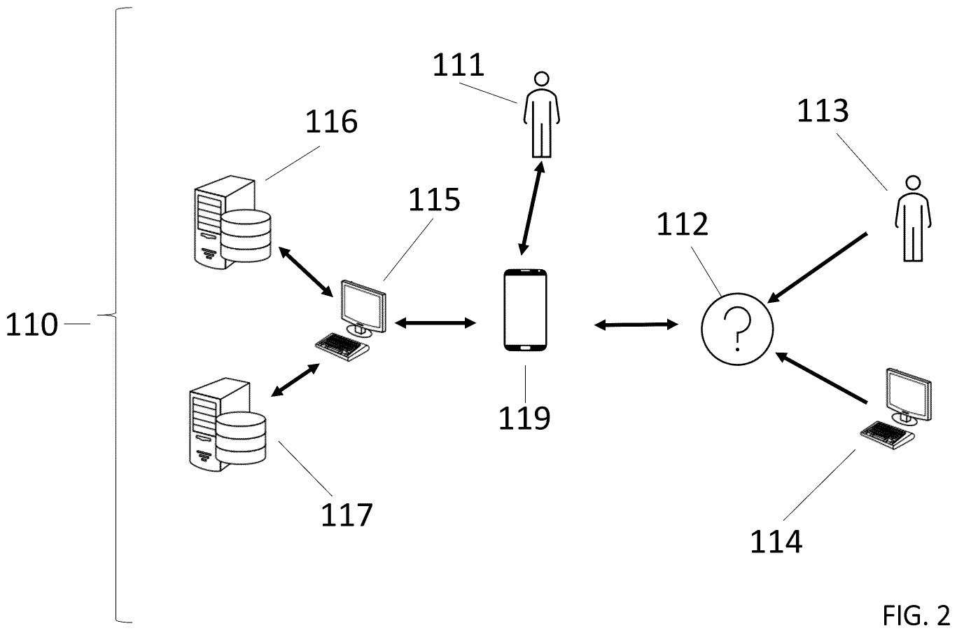

Referring now to FIG. 2 there is shown an implementation of the analysis of the reply signal, according to an example of the present description. A communication mechanism (119) such as a telephone or radio is in communication with a speaker (112). The communication mechanism (119) is in informational communication with one or more processors (115). To a target (111) using the communication mechanism (119), it would be unclear if the speaker (112) is a bona fide human (113) or a bot (114) operating a vocoder to generate a deepfake transmission. Although, theoretically, there could be detectable technical differences between speech from a bona fide human and form a vocoder, in the absence of provoking a speech pattern which highlights those differences, constantly improving vocoder controlling technology are making detection of these differences harder and harder to passively detect.

Upon receipt of the reply from the speaker (112), one or more processors (115) compares the reply to one or more of: a dataset containing expected human replies (116) to the audio signal, a dataset containing expected vocoder replies (117) to the audio signal, or both. A processor (115), can respond to the presence of an expected vocoder reply or the absence of an expected human reply to generate an output signal, detectable by a target (111) indicating a prediction by the processor of the nature of the speaker (112).

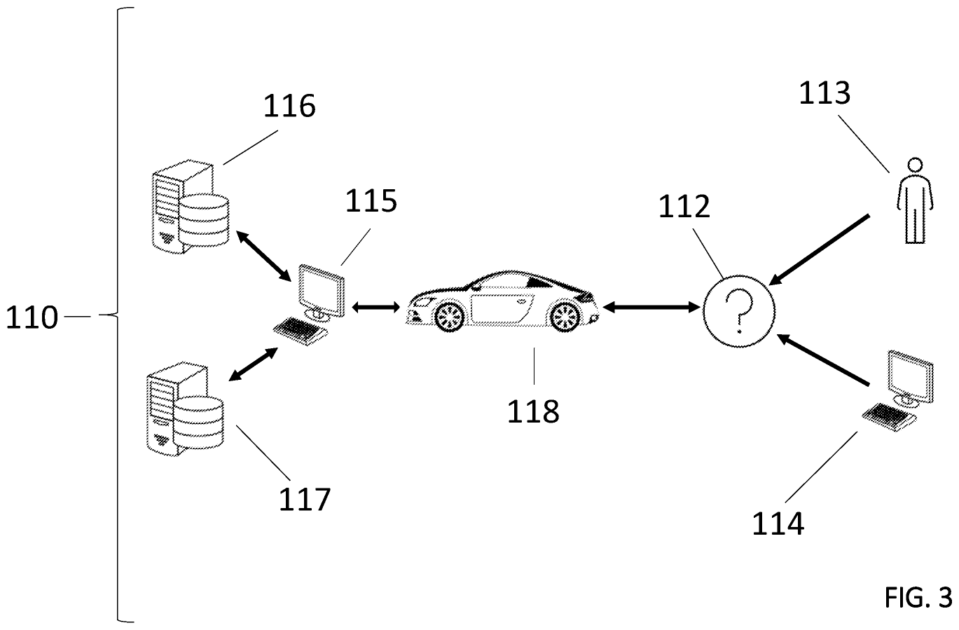

Referring now to FIG. 3 there is shown an example of the present description in which the communication device is constructed and arranged to be housed within an automobile (118). The communication device can utilize components of an advanced driver-assistance systems (ADAS) or can be installed devices independent of such an ADAS. Representative ADAS systems may include various diagnostic and analytical devices such as radar, optical sensors, and cameras which can provide information to the driver or takes automatic action based on what is detected.

The processor (115) and or one or both of the datasets (116 and 117) may be located physically within the automobile or be located elsewhere and are in informational communication with the automobile. Representative examples of communication devices which facilitate information communication between the processor (115) and one or more datasets within the automobile include but are not limited to: automotive data communication buses, CAN (Controller Area Network), differential circuits, LIN (Local Interconnect Network), SCI (UART) Data Format Transmissions, FlexRay, MOST (Media Oriented Systems Transport), Ethernet, OBDII (On-Board Diagnostics II), SAE J1850 PWM, SAE J1850, and SAE J1708, and any combination thereof. Representative examples information communication between the a processor within an automobile and datasets located elsewhere include but are not limited to: node-based vehicle communication systems, short-range communications (DSRC) devices, intelligent transportation systems (ITS), vehicular ad hoc networks (VANETs), mobile ad hoc networks (MANETs), or inter-vehicle communication (IVC), which may utilize one or more of transmission and reception of: short range radio technologies, WLAN (either standard Wi-Fi or ZigBee), cellular technologies, LTE, visible light communication (VLC) and/or infrared transmission and reception, and any combination thereof.

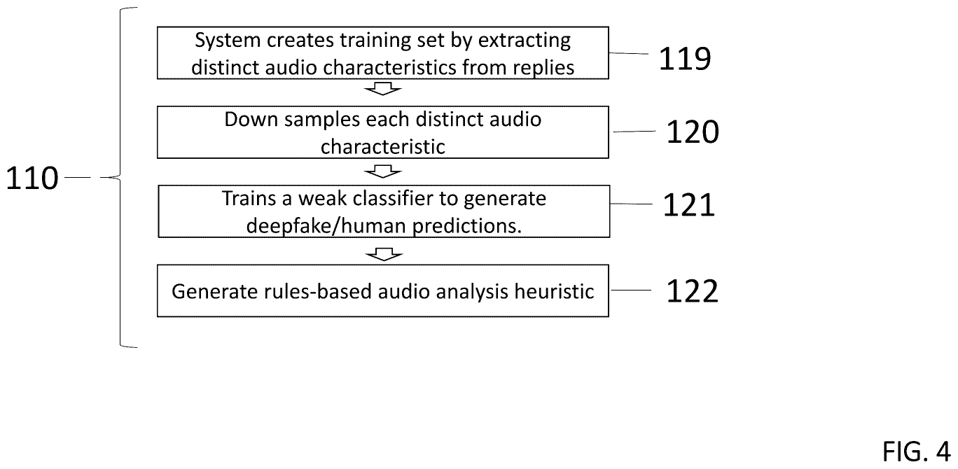

Referring now to FIG. 4 there is shown one form of analysis which makes use of a model trained, based on machine learning methodologies, to distinguish between human and vocoder generated speech, according to an example of the present description. The analysis includes creating a training set. The training set is created by a processor converting an audio signal received from the speaker into a format that can be parsed and analyzed. The formatted signal is then studied to detect distinct audio characteristics (119) within the reply signal. The reply signal is received by the audio receiver subsequent to transmission by the transmitter, to the speaker, of an audio signal containing adjustments intended to provoke a different response from a human than from a bot-controlled vocoder. The model includes a learning algorithm which organizes the audio characteristics into a training dataset. A series of “correct answers” is provided to the model to indicate which audio characteristics are associated with human-type responses and which are associated with vocoder generated responses. Gradually the learning algorithm develops parameters for finding patterns in the training data that map the data sets to correctly associate the characteristics with humans or vocoders. Eventually, these parameters, will correctly associate audio characteristics with either humans or vocoders. The audio characteristics comprise discrete indicators which can be detected within a reply signal, can be populated in a searchable dataset built by the model, and can be searched for within the dataset built by the model. This process outputs a model trained on machine learning that captures these patterns. The resulting model can then attempt to predict whether received signals from the speaker are vocoder or human generated by extracting from the speaker's reply, the distinct audio indicators. This process is recursively repeated with additional data to refine and improve the model's accuracy.

In an example of the present description, a dataset comprises at least three different categories of information. A first category of information is the various audio properties of a given signal. A second category of information is classifications of human reactions. A third category of information is a listing of which of the classifications of human reactions would be expected from a bona fide human speaker in reply to hearing the decoded sound from an audio signal with particular properties. A relational database associating discrete files containing examples of each of these three categories of information is used by a processor to analyze if a given received audio signal is from a vocoder or from a bona fide human.

For example, an audio signal with an inconsistent obnoxious statement embedded within a sequence of words, when heard by a bona fide human speaker, would be expected to evoke from the speaker a response of anger. As a result, in this case, the dataset to model this scenario would comprise a relational database in which a first file is associated with a third file and the third file is associated with a second file. The first file contains the specific audio properties of the words containing the obnoxious statement, the second file contains a classification value representing anger and the third file would include audio files with audio indicators connected to an angry response. A processor would compare the audio properties of the reply received from the speaker to the audio indicators present in the third file. If the comparison resulted in a match, it would suggest that the speaker is a bona fide human. If the comparison resulted in a mismatch, it would suggest that the speaker is a vocoder.

Representative classifications listed among the files for the second category of information include emotional mental states such as one or more of excitement, uncase, anxiety, neurosis, anger, amusement, surprise, and fury. Representative populations for the files of the third category of information include one or more audio files containing attributes of the human speech patterns typically generated in response to one or more of the mental states.

Representative examples of emotions that can be used to categorize various mental states can be discerned by categorizing identifiable speech patterns with other detectable biological processes that manifest from or are the cause of the respective mental states. For example, measurable neurological activity can be used to define discrete mental states. Such measurable neurological activity includes increases or decreases in one or more action potentials between the AIC region of the human brain and at least one other region of the human brain selected from the group consisting of: the ventromedial prefrontal cortex, the posteromedial cortex, the hippocampus, and the amygdala. Also, measurable blood-based activity can be used to define discrete mental states. Such measurable blood-based activity includes increases or decreases in the bloodstream in the presence of at least one neurotransmitter such as cortisol, serotonin, glutamate, gamma-amino butyric acid, cholecystokinin, adenosine, norepinephrine, serotonin, dopamine, and noradrenaline. The dataset can include additional categories of information associated by the relational database to other biological processes. This data from biological processes may also be used by a model trained, based on machine learning methodologies (in the manner described above) to create ever more precise categories of mental states as well as to use those categories to distinguish between human and vocoder generated speech.

In an example of the present description, upon detection of a vocoder, one or more a response action occurs. A response action may be informational, such as a processor indicating to the target and/or to one or more others that the speaker is suspected to be a vocoder and not a bona fide human interlocutor. This information may be displayed on a screen or in the context of an automobile, on a dashboard instrument. The information may be an audio message including words or an alarm, claxon, beep or other sound indicating the deceptive nature of the speaker. The information may also convey that the detection of a vocoder is only suspected as opposed to definitively known. Furthermore, the detection may be ascribed by a processor a probability based on algorithms or by the model. The information might only be communicated if the probability that the speaker is a vocoder exceeds a pre-determined threshold and might include the actual assessed probability.

A response action may be communicative. The communication between the speaker and the target may be summarily severed by a processor. The communication may also be recorded or archived by a processor for evidentiary or other purposes. The recording may be forwarded by a processor to a risk assessment service or law enforcement agency for further actions.

A responsive action may be consequential. Some previously determined sensitive item, or some item specifically mentioned in the conversation, might be secured (virtually or physically). This could include locking down a specific asset within a vault or behind a locked door, ending a line of credit or other financial instrument, or activating a security protocol or procedure. It could also involve contacting third parties mentioned in the conversation or associated with the sensitive item. In the context of an automobile, it could include a processor issuing a message or a mandate to change the destination of the automobile to a more secure facility or location.

In an example of the present description, use of the combination of both provoked and passive techniques are used to detect vocoder speakers. As such, the communication mechanism facilitating conversation between the target and a speaker is in informational communication with one or more processors. In addition to the above method of “intervening” in the conversation, one or more processors passively evaluates other audio characteristics of the speaker's communications received by the communication mechanism independent of the intervention. For example, the processor may scrutinize the speaker's communication for audio elements that cannot or are rarely be uttered by humans, sounds outside or near the limit of the audio spectrum of human voice or the audio spectrum of human hearing, sounds that include elements uttered more frequently or with shorter separations between phonemes than can be done by or are typically done by humans, sounds lacking or misusing fricatives, and or sounds with incorrect terminations. The scrutiny may also compare the predetermined tendency, probability, or frequency of humans to display any of these audio elements with the tendency, probability, or frequency of the audio elements present in messages received from the speaker.

In an example of the present description, one of the passive or interventionist techniques can be used to raise a suspicion that the speaker is a vocoder and the other may be used to confirm or allay the suspicion. For example, a processor may accord a particular weight to a passive detection of a purportedly non-human element and another weight to a provoked purportedly non-human element and may only deem a threshold to have been exceeded upon some combination of the two or more weights. In another example, a first action response may be to communicate to the target the current level of suspicion that the speaker is a vocoder, and an ongoing level of suspicion may be updated and displayed as more than one technique for scrutiny is applied. Subsequent additional action responses may commence by a processor as the level of suspicion increases beyond one or more threshold values. A processor may prompt the target whether it wishes to apply an additional measure to determine if the speaker is human upon an initial suspicion based on an initial passive or provoked detection.

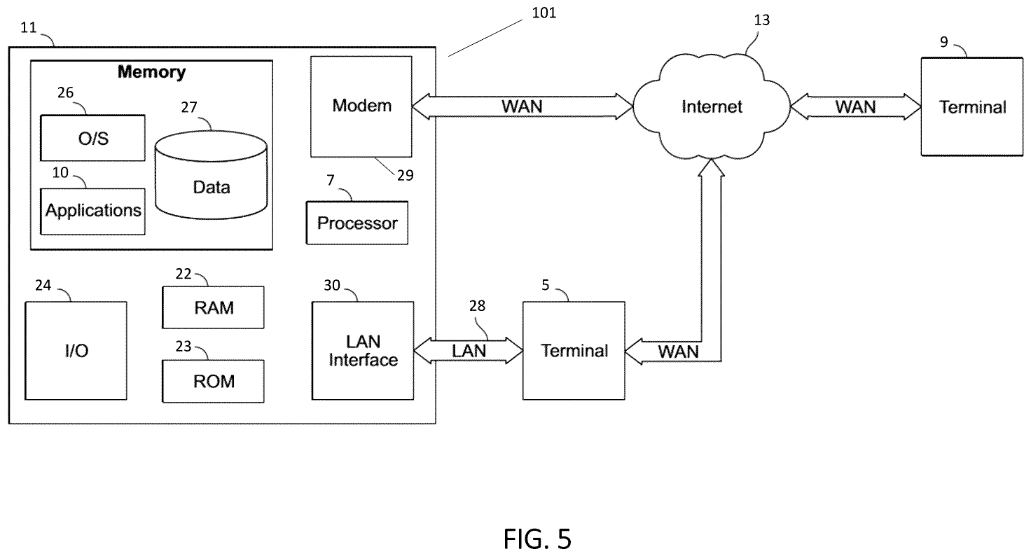

Referring now to FIG. 5, it is shown that embodiments may be a system (101), a method, and/or a computer program product. The computer program product may include a computer readable storage medium (or media) having computer readable program instructions and/or operating system (26) thereon for causing a processor (7) to carry out aspects of the embodiments.

The computer readable storage medium can be a tangible device (11), having input/output modules (24) that can retain and store instructions or applications (10) for use by an instruction execution device. The computer readable storage medium may be, for example, but is not limited to, an electronic storage device (27), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM) (22), a read-only memory (ROM) (23), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (28), a wide area network and/or a wireless network. The network may comprise copper transmission cables, optical transmission fibers, wireless transmission, routers, firewalls, switches, gateway computers and/or edge servers. A network adapter card or network interface (30) in each computing/processing device (7) receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer (5) via a modem (29) or through any type of network, including a local area network (LAN) or a wide area network (WAN), or the connection may be made to an external computer (9) (for example, through the Internet (13) using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant deepfake bots will be developed and the scope of the term deepfake is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any example described as “exemplary” is not necessarily to be construed as preferred or advantageous over other examples and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as to the present description. To the extent that section headings are used, they should not be construed as necessarily limiting. In addition, any priority document(s) of this application is/are hereby incorporated herein by reference in its/their entirety.

What is claimed is:

1. A computer implemented method for authenticating an audio conversation occurring between a first speaker and a target speaker over a communication medium by detection of non-human generated audio output received by the target speaker, comprising:
manipulating an audio signal from the target speaker by incorporating a human audible test which changes at least one property of said audio signal that is selected from a group of properties consisting of: language, speaker age, language fluency, audio gain, accent, jargon, intimacy, familiarity, vocabulary, grammatical tense, genre, coherence, courtesy, grammatical conjugation, formality, harmony, musicality, bass, treble, and emotion, wherein said change in said at least one property in said audio signal is selected to be un-noticed by a non-human listener and to be noticed by a human listener,
forwarding the manipulated audio signal to the first speaker, and
analyzing an audio response by the first speaker to the manipulated audio signal from the target speaker to determine a response action to the audible test.

2. The method of claim 1, wherein the audio signal comprises a coherent sequence of words from a human language and the audible test comprises at least a portion of the audio signal being manipulated to include a at least one item selected from a group consisting of: random phoneme insertion, a change in subject matter, repetition, laughter, crying, screaming, and profanity.

3. The method of claim 1, wherein the audio response by the first speaker comprises a predicted change in in attribute of at least one item selected from the group consisting of: volume, pace, pitch, timbre, and sequence.

4. The method of claim 1 further comprising:
obtaining a first data set of indicators which classify at least one first audio response, the first audio response corresponding to a machine-readable encoding of sound of non-human generated audio response, said machine-readable encoding of sound is generated by a vocoder according to predefined rules for generating audio output in response to receiving a transmission of the manipulated audio signal;
obtaining a second data set of indicators which classify at least one second audio response, the second audio response corresponding to a model of realistic human speech responses to hearing the manipulated audio signal, the first audio response having at least one different audio property from the second audio response;
analyzing the audio response by the first speaker to the manipulated audio signal from the target speaker by detecting whether the response includes: the presence of an indicator of the first data set, the absence of an indicator of the second data set, or both.

5. The method of claim 4 wherein the communication medium comprises an audio input device constructed and arranged to communicate an analog machine-readable encoding of the audio signal to at least one hardware processor constructed and arranged to convert the analog machine-readable encoding of the audio signal into a digital encoding prior to manipulation of the audio signal.

6. The method of claim 4, wherein the at least one audio property that is different between the first audio response and the second audio response is selected from the group consisting of: vocal tract resonance, fundamental frequency, signal amplitude, signal intensity, pitch contour, being interrogative, being imperative, being declarative, being exclamatory, language, the presence of random phonemes, language fluency, audio gain, accent, jargon, intimacy, familiarity, vocabulary, grammatical tense, genre, subject matter, coherence, repetition, courtesy, grammatical conjugation, formality, harmony, musicality, bass, treble, laughter, crying, screaming, profanity, and emotion, volume, pace, word sequence, and invocation of incredulity.

7. The method of claim 4 further comprising the steps of:
training an artificial neural network to develop parameters to govern the populating of the indicators within the first data set, the second data set or both data sets, and
populating at least one of the data sets with indicators according to the developed parameters.

8. The method of claim 4, wherein the second audio response corresponds to a realistic model of human speech responses to hearing the manipulated audio, the human speech response defined by human speech patterns adjusted in response to a mental state selected from the group consisting of: excitement, unease, anxiety, neurosis, anger, amusement, surprise, and fury, and any combination thereof.

9. The method of claim 8 wherein the second audio response to hearing the manipulated audio corresponds with a brain-type response or a blood-type response,
the brain-type response characterized as one or more changes in speech patterns resulting from an increase in action potential between the AIC region of the human brain and at least one other region of the human brain selected from the group consisting of: the ventromedial prefrontal cortex, the posteromedial cortex, the hippocampus, and the amygdala, and any combination thereof, and
the blood-type response characterized one or more changes in speech patterns resulting from an increase in the bloodstream, of the presence of at least one neurotransmitter selected from the group consisting of: cortisol, serotonin, glutamate, gamma-amino butyric acid, cholecystokinin, adenosine, norepinephrine, serotonin, dopamine, and noradrenaline.

10. The method of claim 1 wherein the response action is one item selected from the group consisting of: displaying a text or symbolic warning to the target, emitting an audio warning to the target, communicating to the target a calculated probability that the speaker is a vocoder, terminating the audio conversation, recording the audio conversation, transmitting a recording of the audio the conversation to a preset contact, notifying a preset list of contacts, and any combination thereof.

11. The method of claim 1 wherein, prior to its manipulation, the audio signal further comprises a coherent series of words spoken in a language and the audible test comprise at least one phoneme placed within the series of words, the at least one phoneme selected from the group consisting of: gibberish words, gibberish noises, an unintelligible sound inconsistent with at least one element of grammar and vocabulary of the language, grammatically incorrect words, words in an accent different from the accent of other words within the audio signal, five or more uninterrupted repetitions of a word, and an interrogatory predicate associated with a gibberish subject.

12. A computer implemented method for authenticating an audio conversation occurring between an audio source and a target speaker over a communication medium by detection of non-human generated audio output received by the target speaker, comprising:
manipulating an audio signal from the target speaker by incorporating a human audible test which changes at least one property of said audio signal that is selected from a group of properties consisting of: language, speaker age, language fluency, audio gain, accent, jargon, intimacy, familiarity, vocabulary, grammatical tense, genre, coherence, courtesy, grammatical conjugation, formality, harmony, musicality, bass, treble, and emotion, wherein said change in said at least one property in said audio signal is selected to be un-noticed by a non-human listener and to be noticed by a human listener,
forwarding the manipulated audio signal to the audio source, and
analyzing an audio response by the audio source to the manipulated audio signal from the target speaker to determine a response action to the audible test.

13. A system for identification of rules-based vocoder generated audio output received from a first source by distinguishing the received audio output from human-generated audio output of a target individual, comprising:
an audio input device configured to receive a first sound;
a communication device constructed and arranged to establish real-time communication with a target; and
a non-transitory memory having stored thereon a code for execution by at least one hardware processor, the code comprising:
executable code for manipulating an audio signal to form a manipulated audio signal, by incorporating an audible test which changes at least one property of said audio signal that is selected from a group of properties consisting of: language, speaker age, language fluency, audio gain, accent, jargon, intimacy, familiarity, vocabulary, grammatical tense, genre, coherence, courtesy, grammatical conjugation, formality, harmony, musicality, bass, treble, and emotion, wherein said change in said at least one property in said audio signal is selected to be un-noticed by a non-human listener and to be noticed by a human listener,
executable code for forwarding the manipulated audio signal to the first source via the communication device, and
executable code for analyzing an audio response to the manipulated audio signal received by the communication device from the first source to determine a response action to the audible test.

14. The system of claim 13 further comprising executable code for an analysis of an audio signal received by the communication device other than the audio response, the analysis comprises detection of audio elements having pitch, tone, volume, or timbre outside of a predetermined audio range, having spaces between phonemes outside of a predetermined range, and for determining a response action in response to the analysis.

15. The system of claim 13 further comprising:
a first data store storing data indicators of at least one first audio response, the first audio response corresponding to a machine-readable encoding of sound, generated by a vocoder constructed and arranged to generate a rules-based audio output in response to receiving a transmission of an audio element;
a second data store storing data indicators of at least one second audio response, the second audio response corresponding to a realistic model of human speech responses to hearing the audio element, the first audio response having at least one different audio property from the second audio response;
wherein the executable code for analyzing a response to the manipulated audio signal comprises:
executable code for generating a machine-readable encoding of the first sound,
executable code for generating a machine-readable encoding of a second sound, the second sound including the audio element, the audio element having at least one audio property that differs from at least one audio property of the first sound,
executable code for concatenating at least a portion of the machine-readable encoding of the first sound with the machine-readable encoding of a second sound to produce the manipulated audio signal,
executable code for detecting the presence of data indicators of at least one first audio response within the response,
executable code for detecting the presence of data indicators of at least one second audio response within the response,
executable code to indicate that the response contains rules-based vocoder generated audio output if a first audio response is detected, if a second audio response is not detected or both; and
at least one data output device configured to indicate if the second signal included rules-based vocoder generated audio output.

16. The system of claim 15 wherein the indicators of the second data set correspond with human speech patterns adjusted in response to unease, anxiety, neurosis, anger, amusement, surprise, and fury.

17. The system of claim 13 further comprising the non-transitory memory having stored thereon a code for execution by at least one hardware processor, comprising executable code for training an artificial neural network to develop parameters to govern the populating of the data indicators within the first data store, the second data store or both data stores, and populating at least one of the data stores with indicators according to the developed parameters.

18. The system of claim 13 wherein:
the executable code for manipulating an audio signal creates, by one or more processors, a data set comprising a first plurality of audio responses to an audio cue known to model typical human responses to the audio cue, and a second plurality of audio responses known to model an audio response generated by a vocoder constructed and arranged to generate a rules-based audio output in response to the audio cues;
the executable code for forwarding the manipulated audio signal transmits to a first source, an audio communication including the audio cue;
the executable code for analyzing a response:
receives in reply to the transmitted audio communication, an audio reply from the first source and identifies within the audio reply, the presence or absence of: the first plurality of audio responses or the second plurality of audio responses,
creates, by one or more processors, a training set, wherein the training set comprises the first and second plurality of audio responses;
identifies, by the one or more processors, a distinct characteristic in each audio response of the training set;
extracts, by the one or more processors, the distinct characteristic from each audio response of the training set;
down-samples, by the one or more processors, the extracted distinct characteristic in at least one fraction of the audio response; and
trains, by the one or more processors, a weak classifier to, based on the distinct characteristic and the down-sampled distinct characteristic, to generate a prediction result on whether an audio reply is generated by a vocoder constructed and arranged to generate a rules-based audio output or by a human speaker.
